(19) United States
(12) Patent Application Publication
(10) Pub. No.: US 2012/0044875 A1
(43) Pub. Date: Feb. 23, 2012

(54) Uplink Communications

(75) Inventors: Markku Kurtti, Oulu (FI); Janne Ilari Blankenstein, Oulu (FI); Antti Olavi Hiltunen, Oulu (FI); Jukka Kalervo Rahikkala, Oulu (FI)

(73) Assignee: NOKIA CORPORATION, Espoo (FI)

(21) Appl. No.: 13/319,013

(22) PCT Filed: Mar. 23, 2010
(86) PCT No.: PCT/FI10/50219

§ 371 Date: Nov. 4, 2011

Related U.S. Application Data
(60) Provisional application No. 61/215,341, filed on May 4, 2009.

(51) Int. Cl. H04W 74/04; H04W 52/04; H04W 92/00

(52) U.S. Cl. 370/328

(57) ABSTRACT

A method including communicating by an apparatus with base stations using a high speed uplink packet transmission technique that provides the apparatus with serving and non-serving links to base stations as well as scheduled transmissions in a serving link. A transmission power downgrading command is detected at the apparatus from a non-serving link. In a situation in which no scheduled transmission took place by the apparatus during preceding transmission period, the downgrading command is prevented from causing the apparatus to start applying a lowest value of a variable or parameter that defines the transmission power or power ratio for scheduled transmission.

### TECHNICAL FIELD

The present invention generally relates to communications in an uplink direction. The invention relates particularly, though not exclusively, to high speed uplink packet transmission for mobile terminals.

### BACKGROUND ART

Current standard specifications enable not only high speed packet access in a downlink direction, that is, from base station (node B or similar) to terminal, but also in the opposite, uplink direction, that is, from terminal to base station.

High Speed Packet Access (HSPA) is one example collection of high speed packet transmission technologies including a specific High Speed Uplink Packet Access (HSUPA) technology, occasionally also called Enhanced Uplink (EUL). One purpose is to improve the performance of the existing WCDMA (Wideband Code Division Multiple Access) technology standardized by the 3GPP. The maximum uplink speeds achieved by these technologies may be around 5.8 Mbit/s, or 11 Mbit/s, or even more with an evolved high speed packet transmission technology, such as a HSPA+ technology or similar, or with a yet more evolved future technology.

In the connection of high speed uplink packet transmission technologies, the current specifications typically define that the terminals (user equipment, UE or similar) request a permission to send data and the base stations decide when and how many terminals will be allowed to do so. In addition to a scheduled mode of uplink transmission the current specifications typically allow a self-initiated transmission mode from the terminals, denoted non-scheduled.

The feature serving (scheduled) grant (SG) is used to basically define a limit for scheduled data that is allowed to be transmitted in the uplink direction on a dedicated transport channel, such as enhanced dedicated channel (E-DCH) or similar. One way for implementing the serving grant feature is to use a downlink signaling channel for transmitting transmission power commands from the base station(s) to terminals concerning transmission power to be used at the terminal in uplink transmission. This signaling channel may be a physical channel, such as a relative grant channel (E-RGCH) or similar. The power used by the scheduled transmission flows is typically controlled dynamically by the base station through absolute grant (i.e., signaling an actual value) and relative grant commands (i.e., single UP, HOLD or DOWN commands).

Concerning relative grant commands, base stations in practice indicate to the terminal by UP that a terminal can send more (and cause more interference), by HOLD to maintain current data rate and DOWN means that the terminal must tune down the power it uses (due to the fact that there might be too much interference in the cell, for example). Relative grant commands UP or DOWN make the SG to change in relation to data transmitted during preceding transmission period.

The terminal can detect relative grant commands from serving and non-serving links. A serving link is the primary link to be used and a non-serving link can be, for example, a link to a base station in an adjacent cell in a soft handover case where the terminal is in communication with several base stations at a time.

The current specifications concerning different high speed uplink packet transmission technologies do not readily present solutions to all problem situations discovered previously, let alone that new problem situations will be discovered from time to time.

### SUMMARY

According to a first example aspect of the invention there is provided a method comprising:

communicating by an apparatus with base stations using a high speed uplink packet transmission technique that provides the apparatus with serving and non-serving links to base stations as well as scheduled transmissions in a serving link; detecting a relative grant command at the apparatus from a non-serving link; and in a situation in which no scheduled transmission took place by the apparatus during preceding transmission period, preventing the detected command from causing the apparatus to start applying a lowest value of a variable or parameter that defines or controls the transmission power or power ratio for scheduled transmission.

Accordingly, it has been observed in accordance with an embodiment of the invention that undesired transmission power downgrading can be prevented if, for example, a downgrading command detected from the non-serving link is interpreted by the apparatus in the mentioned specific situation in the mentioned specific way (that is, by preventing the lowest value of the variable or parameter directly or indirectly defining transmission power to be applied). In that case the apparatus in an embodiment may continue to use the current value of said variable or parameter, or may begin to use another value, lower than the current value but higher than a minimum value.

The above is in contrast to current specifications which typically define that in the mentioned situation the apparatus has to start applying the lowest value. In high speed uplink packet transmission technologies that use a serving (scheduled) grant feature (SG) that defines a limit for scheduled data that is allowed to be transmitted in the uplink direction on an dedicated transport channel, the lowest value may be defined as the SG having the lowest value, typically SG=0. In an embodiment the lowest value may be defined as a state variable, such as reference_ETPR or reference_ETPR2, having a value indicating minimum grant, such as a value Minimum_Grant.

The relative grant command may be a command that is used to control the data rate or transmission power of uplink transmissions.

In an embodiment, the relative grant command is a relative grant channel command, such as an E-RGCH command. In an embodiment, the relative grant command is a transmission power or data rate downgrading command, such as a DOWN command, or a command to maintain current data rate or transmission power, such as a HOLD command.

In an embodiment, in response to detecting the relative grant command at the apparatus, the use of the current value of variable or parameter that defines or controls the transmission power or power ratio for scheduled transmission is continued by the apparatus. In an embodiment, this can be implemented by continuing to use the value of the parameter or variable that was used during the preceding (or immediately preceding) transmission period.

In an embodiment, the preceding transmission period is a transmission time interval (TTI) corresponding to previous transmission on current hybrid automatic repeat request (HARQ) process. In an embodiment, the preceding transmission period is a set (window) of TTIs comprised of active HARQ processes transmitted one HARQ process round trip time (RTT) ago in the past.

In an embodiment, when the apparatus has more than one active transmission process (i.e., a group of transmission processes, such as HARQ processes), in the situation in which the relative grant command is detected at the apparatus from the non-serving link and in which no scheduled transmission took place by the apparatus during the preceding transmission period, the method comprises preventing the detected command from causing the apparatus to start applying the lowest value of said variable or parameter to the transmission process that had the highest transmission power of the group in the (near) past.

According to a second example aspect of the invention there is provided an apparatus comprising:

a communication unit configured to communicate with base stations using a high speed uplink packet transmission technique that provides the apparatus with serving and non-serving links to base stations as well as scheduled transmissions in a serving link, the communication unit further being configured to detect a relative grant command from a non-serving link; and

a processor configured to prevent, in a situation in which no scheduled transmission took place by the apparatus during preceding transmission period, the detected command from causing the apparatus to start applying a lowest value of a variable or parameter that defines or controls the transmission power or power ratio for scheduled transmission.

According to a third example aspect of the invention there is provided a computer program comprising program code executable in an apparatus, and when executed causing the apparatus to perform the operations of:

communicating with base stations using a high speed uplink packet transmission technique that provides the apparatus with serving and non-serving links to base stations as well as scheduled transmissions in a serving link;

detecting a relative grant command at the apparatus from a non-serving link; and

in a situation in which no scheduled transmission took place by the apparatus during preceding transmission period, preventing the detected command from causing the apparatus to start applying a lowest value of a variable or parameter that defines or controls the transmission power or power ratio for scheduled transmission.

According to a fourth example aspect of the invention there is provided a memory medium carrying the computer program of the third example aspect. The memory medium may be a digital data storage such as a data disc or diskette, optical storage, magnetic storage, holographic storage, phase-change storage (PCM) or opto-magnetic storage. The memory medium may be formed into a device without other substantial functions than storing memory or it may be formed as part of a device with other functions, including but not limited to a memory of a computer, a chip set, and a sub assembly of an electronic device.

According to a fifth example aspect of the invention there is provided an apparatus comprising:

means configured to communicate with base stations using a high speed uplink packet transmission technique that provides the apparatus with serving and non-serving links to base stations as well as scheduled transmissions in a serving link, the means further being configured to detect a relative grant command from a non-serving link; and

means configured to prevent, in a situation in which no scheduled transmission took place by the apparatus during preceding transmission period, the detected command from causing the apparatus to start applying a lowest value of a variable or parameter that defines or controls the transmission power or power ratio for scheduled transmission.

According to a yet another example aspect of the invention there is provided a method comprising:

communicating by an apparatus with base stations using a high speed uplink packet transmission technique that provides the apparatus with serving and non-serving links to base stations as well as scheduled transmissions in a serving link;

detecting a data rate or transmission power downgrading command at the apparatus from a non-serving link; and

in a situation in which no scheduled transmission took place by the apparatus during preceding transmission period, preventing the detected downgrading command from causing the apparatus to start applying a lowest value of a variable or parameter that defines or controls the transmission power or power ratio for scheduled transmission in a serving link.

An apparatus, computer program and memory medium carrying the computer program may be similarly provided.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows a schematic picture of an example system according to an embodiment of the invention;

FIG. 2 shows a flow chart depicting a method according to an embodiment of the invention; and

FIG. 3 shows a block diagram of a terminal of FIG. 1.

### DETAILED DESCRIPTION

In the following description, like numbers denote like elements.

As mentioned in the background art section, current standard specifications enable not only high speed packet access in a downlink direction, that is, from base station (node B or similar) to terminal, but also in the opposite, uplink direction, that is, from terminal to base station.

The embodiments of the present invention are suitable to be implemented in systems presented in the background art section. The systems comprise systems taking advantage of high speed uplink packet transmission technologies.

High Speed Packet Access (HSPA) is one example collection of high speed packet transmission technologies including a specific High Speed Uplink Packet Access (HSUPA) technology, occasionally also called Enhanced Uplink (EUL). One of their purposes is to improve the performance of the existing WCDMA (Wideband Code Division Multiple Access) technology standardized by the 3GPP. The maximum uplink speeds achieved by these technologies may be around 5.8 Mbit/s, or 11 Mbit/s, or even more with an evolved high speed packet transmission technology, such as a HSPA+ technology or similar. The embodiments of the invention are applicable also in systems taking advantage of yet more evolved future technologies.

An example system in accordance with an embodiment of the invention is presented in the following. The system may be a HSUPA system or a system generally in line with the HSUPA system. However, embodiments of the invention may typically also be used in other systems employing a high speed uplink packet transmission technology.

In the example system the terminals (user equipment, UE or similar) request a permission to send data and the base stations decide when and how many terminals will be allowed to do so. In addition to a scheduled mode of uplink transmission the example system allows a self-initiated transmission mode from the terminals, denoted non-scheduled.

The feature scheduled grant (SG) is used to basically define a limit for scheduled data that is allowed to be transmitted in the uplink direction on a dedicated transport channel, such as enhanced dedicated channel (E-DCH) or similar. One way for implementing the scheduled grant feature is to use a downlink signaling channel for transmitting transmission power commands from the base station(s) to terminals concerning transmission power to be used at the terminal in uplink transmission. This signaling channel may be a physical channel, such as a relative grant channel (E-RGCH) or similar. The power used by the scheduled transmission flows is typically controlled dynamically by the base station through absolute grant (i.e., signaling an actual value) and relative grant commands (i.e., single UP, HOLD or DOWN commands).

Concerning relative grant commands, base stations in practice indicate to the terminal by UP that a terminal can send more (and cause more interference) , by HOLD to maintain current data rate and DOWN means that the terminal must tune down the power it uses (due to the fact that there might be too much interference in the cell, for example). Relative grant commands (UP or DOWN) are meant to make the SG to change in relation to data transmitted during preceding transmission period.

The terminal can detect relative grant commands from serving and non-serving links. A serving link is the primary link to be used and a non-serving link can be, for example, a link to a base station in an adjacent cell in a soft handover case where the terminal is in communication with several base stations at a time. A detected command may be transmitted by a base station, however a terminal may also erroneously detect a command that was not transmitted from a base station. If a terminal detects a DOWN command when one was not sent, it may downgrade transmissions unnecessarily.

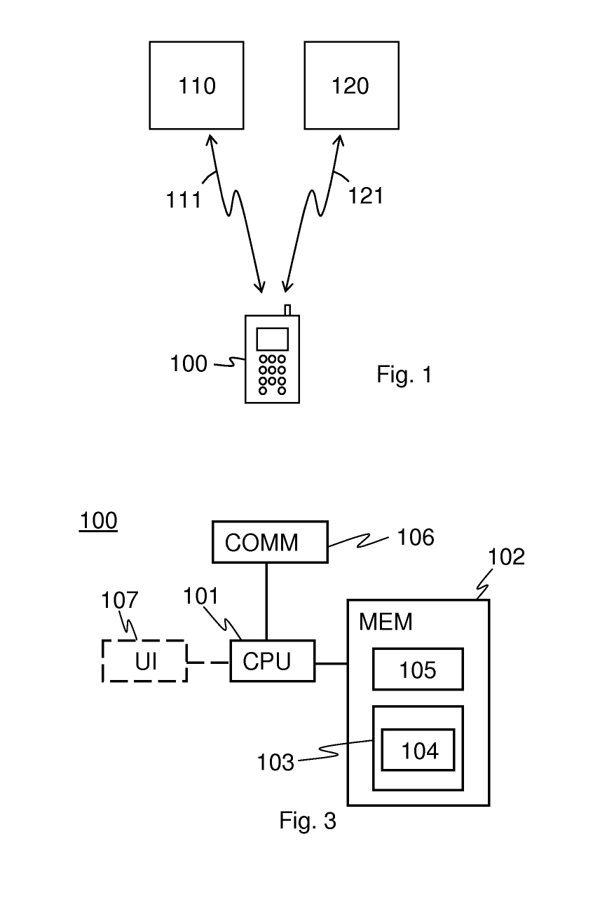

FIG. 1 shows a schematic picture of the example system according to an embodiment of the invention. The terminal 100 communicates simultaneously with two base stations 110 and 120 over a communications link, typically a radio link (RL). The communications link 111 with the base station 110 is a serving link and the communications link 121 with the base station 120 is a non-serving link.

The terminal 100 transmits scheduled data transmission on a dedicated transport channel, such as enhanced dedicated channel (E-DCH) and detects relative grant commands from base stations 110 and 120 on signaling channel(s), such as a relative grant channel (E-RGCH). In an embodiment, a medium access control MAC-d entity handles the (enhanced) dedicated transport channel. The scheduled data transmission may be implemented as a MAC-d flow or similar. This typically represents a QoS flow.

In a specific example embodiment, an E-DCH dedicated physical data channel (E-DPDCH) is used to carry the E-DCH transport channel and an E-DCH dedicated physical control channel (E-DPCCH) is used to carry control information associated with the E-DCH.

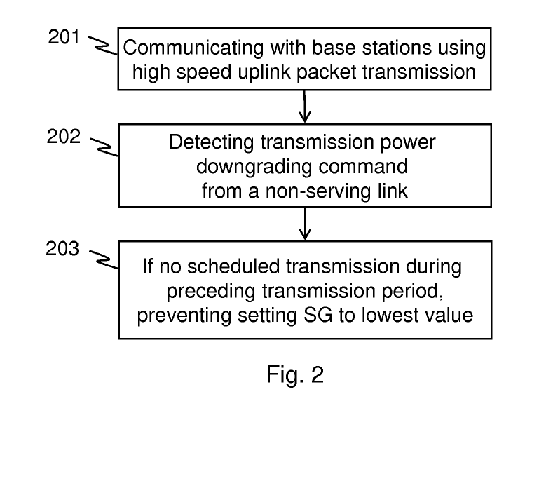

FIG. 2 shows a flow chart depicting a method according to an embodiment of the invention. Step 201 generally defines that the terminal 100 communicates with base stations 110 and 120 using a high speed uplink packet transmission technique. In step 203, if a downgrading command (such as, for example a relative grant DOWN command or in some circumstances HOLD) from a non-serving link has been detected in step 202, and if no scheduled transmission took place during the previous transmission period for scheduled transmission, it is prevented that the serving grant (or scheduled grant) would be set to a lowest value. In this way, undesired downgrading due to detected non-serving relative grant downgrading command can be prevented.

In a specific non-limiting example embodiment concerning a specific existing high speed uplink packet access (HSUPA) example system presented in the following, undesired SG downgrading due to a detected relative grant DOWN command on non-serving E-DCH RL E-RGCH channel is prevented.

Presently, in this system it is allowed on E-RGCH from non-serving E-DCH RL to make a certain number of false (DOWN) detections from noise in certain radio channel conditions. Upon detecting the relative grant DOWN command at the terminal 100 a serving grant update procedure is performed. The serving grant update procedure uses a reference_ETPR or reference_ETPR2 state variable that holds the E-DPDCH to DPCCH power ratio used as reference for relative grant commands. In existing standards the reference_ETPR or reference_ETPR2 is defined to be set to Minimum_Grant in case no scheduled transmission took place on a HARQ process in the previous TTI.

Due to how the serving grant update and handling of relative grants has been defined in existing standards, if (false) DOWN is detected from non-serving E-DCH RL E-RGCH and no scheduled transmission took place on a HARQ process in previous TTI, SG is presently set to Minimum_Grant (usually SG 0). SG 0 may effectively block scheduled E-DCH transmission. Blocked E-DCH impacts HSUPA throughput and functionality.

Accordingly, in accordance with an embodiment of the invention, if a DOWN command on non-serving E-DCH RL E-RGCH is detected at the terminal 100 and no scheduled transmission took place on a HARQ process in the previous TTI (reference_ETPR equals Minimum_Grant) or during any of the active HARQ processes in preceding time window (maximum of all active reference_ETPR2 equals Minimum_Grant), setting SG to Minimum Grant is prevented. In this way undesired SG downgrading can be prevented.

The following description presents different ways to implement preventing of undesired downgrading of scheduled transmissions on a serving link. The presented alternatives are described in the context of high speed uplink packet access (HSUPA) example system although the intention is not to limit only to this technology.

### Embodiment Alternative A

In this embodiment, the terminal is forced, for example with controlling by software, to handle non-serving E-RGCH DOWN commands in Serving Grant Update procedure taking the following condition into account:

“If there was a scheduled transmission in the previous TTI of the HARQ process given by the value of CURRENT_HARQ_PROCESS” (concerning existing 3GPP specifications of Release6 and Release7)

“If there was a scheduled transmission in the TTI corresponding to maximum reference_ETPR2” (concerning 3GPP specifications of Release8 and onwards)

And only if this condition is fulfilled should Serving Grant be updated upon detecting non-serving E-RGCH DOWN command.

More generally, the terminal is forced to obey the following rule:

If a power downgrading command is detected over a non-serving link, update serving grant only if there was a scheduled transmission in the preceding transmission period (during the previous TTI of the applied HARQ process or during the time window comprising all active HARQ processes one RTT from the past).

### Embodiment Alternative B

In this embodiment, the terminal is forced, for example with controlling by software, to handle the state variable reference_ETPR (and eventually reference_ETPR2) as follows:

In case no scheduled transmission took place on a HARQ process in the previous TTI, reference_ETPR shall be set to current Serving grant.

More generally, the terminal is forced to obey the following rule in the event it detects a downgrading command from the non-serving link:

In case no scheduled transmission took place in the preceding transmission period (or during the previous TTI of the applied HARQ process), a state variable defining a power ratio of a dedicated physical data channel to a dedicated physical control channel shall be set to current serving grant.

### Embodiment Alternative C

In this embodiment, a parameter or variable, such as “non-serving grant”, is signaled from base station to terminal on each non-serving E-DCH RL. The terminal is configured to receive the parameter or variable. It indicates to the terminal the lowest SG value which can be caused by a DOWN command from the non-serving RL. This floor value prevents SG being lowered too much by the terminal in the event a downgrading command is detected from the non-serving link.

### Embodiment Alternative D

In this embodiment the terminal calculates SG corresponding to the minimum configured MAC-layer PDU size and does not allow SG go lower than this limit due to non-serving E-RGCH DOWN commands.

The following presents some existing and non-limiting E-DCH specific definitions:

Serving_Grant (FDD): The state variable Serving_Grant indicates the maximum E-DPDCH to DPCCH power ratio that the UE is allowed to use for scheduled data in the following transmission. The value in the appropriate state variable will be provided to the E-TFC selection function to help in selecting the best format for the upcoming transmission.

Minimum_Grant: The value Minimum_Grant corresponds to the minimum E-DPDCH to DPCCH power ratio that the UE considers. This value is in index 0 of a configured scheduling grant table.

Non-serving E-DCH RL or Non-serving RL: Cell which belongs to the E-DCH active set but does not belong to the Serving E-DCH RLS and from which the UE can receive one Relative Grant. The UE can have zero, one or several Non-serving E-DCH RL(s).

reference_ETPR: The state variable reference_ETPR holds the E-DPDCH to DPCCH power ratio used as reference for relative grant commands. This variable is set to the E-DPDCH to DPCCH power ratio used for the E-TFC selected for the previous TTI on this HARQ process, calculated using the amplitude ratios prior to the quantization, excluding non-scheduled transmissions, excluding any scaling applied and is obtained from the physical layer. In case no scheduled transmission took place on a HARQ process in the previous TTI, reference_ETPR shall be set to Minimum_Grant for this HARQ process.

reference_ETPR2: The state variable reference_ETPR2 holds the E-DPDCH to DPCCH power ratio used as reference for non serving relative grant commands. This variable is set to the previously stored reference_ETPR on this HARQ process when the reference_ETPR is updated with a new value.

FIG. 3 shows a block diagram of a terminal according to an embodiment of the invention. The terminal 100 comprises a memory 102 including a persistent memory 103 configured to store computer program code 104. The terminal 100 further comprises a processor 101 for controlling the operation of the terminal 100 using the computer program code 104, a work memory 105 for running the computer program code 104 by the processor 101, and a communication unit 106 for communicating with the base stations 110 and 120. It also typically comprises a user interface 107 including a display and keypad for operating the terminal 100 by a user. The processor 101 may be a master control unit (MCU). Alternatively, the processor may be a microprocessor, a digital signal processor (DSP), an application specific integrated circuit (ASIC), a field programmable gate array, a microcontroller or a combination of such elements.

As to the operations of the embodiments of the invention, the communication unit 106 is configured to communicate with base stations using a high speed uplink packet transmission technique that provides the terminal apparatus 100 with serving and non-serving links to base stations 110 and 120 as well as scheduled transmissions in a serving link 111. The communication unit 106 is further configured to detect any relative grant (E-RGCH) command from the non-serving link 121. The processor 101 is configured to control the operation of the communication unit 106 in accordance with the computer program code 104. The processor 101 is further configured to prevent, as controlled by the computer program code 104, in a situation in which no scheduled transmission took place by the apparatus during a preceding transmission period, detected downgrading command from causing the apparatus to start applying a lowest value of a variable or parameter that defines the transmission power or power ratio for scheduled transmission in the serving link.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1.-21. (canceled)

22. A method comprising:
communicating by an apparatus with base stations using a high speed uplink packet transmission technique that provides the apparatus with serving and non-serving links to base stations as well as scheduled transmissions in a serving link;
detecting a relative grant command at the apparatus from a non-serving link; and
in a situation in which no scheduled transmission took place by the apparatus during preceding transmission period, preventing the detected command from causing the apparatus to start applying a lowest value of a variable or parameter that defines or controls the transmission power or power ratio for scheduled transmission.

23. The method of claim 22, wherein said preventing is performed if a relative grant command DOWN is detected at the apparatus and no scheduled transmission took place on a transmission (HARQ) process in a previous transmission time interval (reference_ETPR equals Minimum_Grant) or during any of the active transmission (HARQ) processes in a preceding time window (maximum of all active reference_ETPR2 equals Minimum_Grant).

24. The method of claim 23, wherein said preventing is performed by preventing Serving_Grant from being set to Minimum_Grant.

25. The method of claim 22, wherein said preventing is performed in a situation in which no scheduled transmission took place by the apparatus during any of the active transmission (HARQ) processes in a preceding time window.

26. The method of claim 22, wherein the relative grant command is a transmission power downgrading command or data rate downgrading command, or a command to maintain current data rate or transmission power.

27. The method of claim 22, wherein the relative grant command is a HOLD or DOWN command on a relative grant channel (E-RGCH or similar).

28. The method of claim 22, wherein the use of a current value of said variable or parameter is continued.

29. The method of claim 22, wherein the scheduled transmission is a transmission occurring on an uplink transport channel.

30. The method of claim 22, wherein the transmission power downgrading command is a detected relative grant command requiring a power change in relation to scheduled data transmitted during a preceding transmission period.

31. An apparatus comprising:
a communication unit configured to communicate with base stations using a high speed uplink packet transmission technique that provides the apparatus with serving and non-serving links to base stations as well as scheduled transmissions in a serving link, the communication unit further being configured to detect a relative grant command from a non-serving link; and
a processor configured to prevent, in a situation in which no scheduled transmission took place by the apparatus during preceding transmission period, the detected command from causing the apparatus to start applying a lowest value of a variable or parameter that defines or controls the transmission power or power ratio for scheduled transmission.

32. The apparatus of claim 31, wherein the apparatus is configured to perform said preventing if a relative grant command DOWN is detected at the apparatus and no scheduled transmission took place on a transmission (HARQ) process in a previous transmission time interval (reference ETPR_equals Minimum_Grant) or during any of the active transmission (HARQ) processes in a preceding time window (maximum of all active reference_ETPR2 equals Minimum_Grant).

33. The apparatus of claim 32, wherein the apparatus is configured to perform said preventing by preventing Serving_Grant from being set to Minimum_Grant.

34. The apparatus of claim 31, wherein the relative grant command is a transmission power downgrading command or data rate downgrading command, or a command to maintain current data rate or transmission power.

35. The apparatus of claim 31, wherein the relative grant command is a HOLD or DOWN command on a relative grant channel (E-RGCH or similar).

36. The apparatus of claim 31, wherein the apparatus is configured to continue using a current value of said variable or parameter.

37. The apparatus of claim 31, wherein the scheduled transmission is a transmission occurring on an uplink transport channel.

38. The apparatus of claim 31, wherein the transmission power downgrading command is a detected relative grant command requiring a power change in relation to scheduled data transmitted during a preceding transmission period.

39. The apparatus of claim 31, wherein the apparatus is a mobile terminal.

40. A computer program product embodied on a non-transitory storage medium, comprising program code executable in an apparatus, and when executed causing the apparatus to perform the operations of
communicating with base stations using a high speed uplink packet transmission technique that provides the apparatus with serving and non-serving links to base stations as well as scheduled transmissions in a serving link;
detecting a relative grant command at the apparatus from a non-serving link; and
in a situation in which no scheduled transmission took place by the apparatus during preceding transmission period, preventing the detected command from causing the apparatus to start applying a lowest value of a variable or parameter that defines or controls the transmission power or power ratio for scheduled transmission.

41. An apparatus comprising:
means configured to communicate with base stations using a high speed uplink packet transmission technique that provides the apparatus with serving and non-serving links to base stations as well as scheduled transmissions in a serving link, the means further being configured to detect a relative grant command from a non-serving link; and
means configured to prevent, in a situation in which no scheduled transmission took place by the apparatus during preceding transmission period, the detected command from causing the apparatus to start applying a lowest value of a variable or parameter that defines or controls the transmission power or power ratio for scheduled transmission.
